(19) United States
(12) Patent Application Publication
(10) Pub. No.: US 2003/0100350 A1
(43) Pub. Date: May 29, 2003

(54) Speakerphone mute indicator

(76) Inventors: Kevin Dotzler, San Diego, CA (US); Alex Chan, San Diego, CA (US); John W. Thomas, Carlsbad, CA (US)

Correspondence Address: HARNESS, DICKEY & PIERCE, P.L.C., P.O. BOX 828, BLOOMFIELD HILLS, MI, 48303, US

(21) Appl. No.: 09/995,477

(22) Filed: Nov. 27, 2001

(51) Int. Cl. H04M 1/00

(52) U.S. Cl. 455/569; 455/425; 455/566

(57) ABSTRACT

A telephone includes an indicator which alerts a user that the telephone has stopped receiving data and is ready for transmission. Thus, when operating as a speakerphone, the indicator alerts the user that the other party has stopped speaking and the user may begin speaking. The indicator may also indicate that the telephone is receiving data and the telephone is not ready for transmission.

### TECHNICAL FIELD

This invention relates to telephone communications, and more particularly to providing a mute indicator in a half-duplex speakerphone.

### BACKGROUND

Speakerphones allow several users at one end of a telephone connection to participate in the telephone conversation. Even in the case of a telephone conversation between two users, a speakerphone provides the advantage of allowing the user to participate in the conversation without having to hold a handset or wear a headset. Such hands-free operation gives the user the freedom to move about the room or type at a computer terminal while participating in the conversation.

Speakerphones operating in a half-duplex mode have an internal monitoring circuit which switches the speakerphone between “send” and “receive” modes thereby preventing the acoustical output of the speaker from being picked up by the microphone and causing feedback. Half-duplex transmissions occur in only one direction at a given point in time. Therefore, it is a common practice in such a system to temporarily deactivate the microphone at a given site while that site is receiving a transmission and to mute the speaker at either site to eliminate audio feedback being received by the remote site.

Half duplex systems suffer from a problem that only one person of a two-person conversation can speak at any given time. Typically, a user must wait until the other end is silent before beginning to speak. However, it is often difficult to determine exactly when the other party has stopped speaking, and some speech may be lost if one side attempts to speak before the other side stops. Unfortunately, the parties are unaware their speech has been cut-off unless notified by the other party. What is needed is a system that informs each party when the line is available.

### SUMMARY

A telephone includes an indicator which alerts a user that the telephone has stopped receiving data and is ready for transmission. Thus, when operating as a speakerphone, the indicator alerts the user that the other party has stopped speaking and the user may begin speaking. The indicator may also indicate that the telephone is receiving data and the telephone is not ready for transmission.

### DESCRIPTION OF DRAWINGS

These and other features and advantages of the invention will become more apparent upon reading the following detailed description and upon reference to the accompanying drawings.

FIG. 1 illustrates a telephone including an indicator according to one embodiment of the present invention.

FIG. 2 illustrates the process for providing an indication to the user that the telephone channel is available according to one embodiment of the present invention.

### DETAILED DESCRIPTION

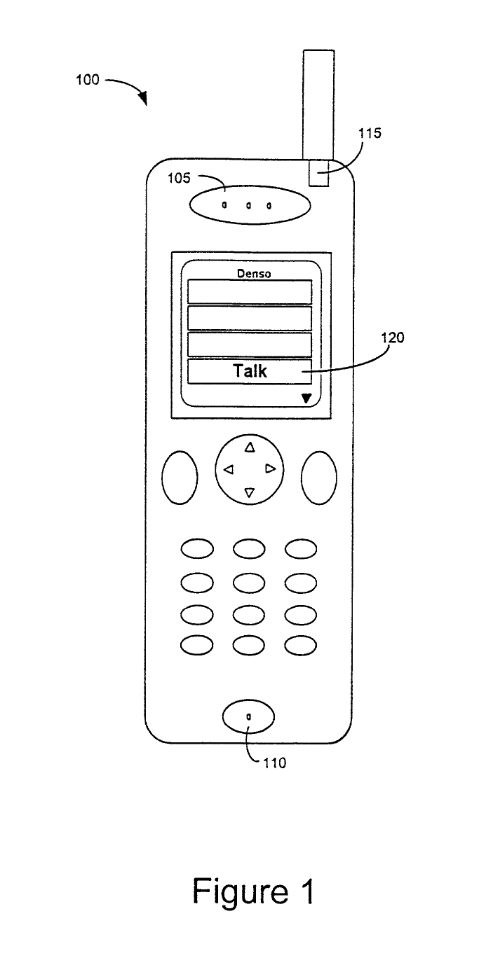

FIG. 1 illustrates a telephone 100 according to one embodiment including an indicator 115. The telephone 100 includes a speaker 105 and a microphone 110. During normal phone conversations, a user may place the speaker 105 against his ear and speak into the microphone 110. During this normal usage, the telephone 100 operates in full-duplex mode, and the user may speak at the same time the voice from the other party is arriving. When the telephone 100 is used as a speakerphone, the volume from the speaker 105 is increased so the incoming voice may be heard when the speaker 105 is not directly against the user's ear.

The indicator 105 may include one or more light emitting diodes (LED). For example, a green LED may be used to indicate the channel is not currently receiving any data, and thus is available for the user to speak. A red LED may be used when incoming data is being received, indicating that the channel is not available for the user to speak. Although an indication may be used to indicate that the channel is both available and not available, it can be appreciated that only one indication is required. Thus, is only a green LED were used, the user would know to speak when the green LED were lit and not to speak when the green LED was not lit.

The indicator 115 does not have to be limited to a visual, LED type indication. The telephone 100 may also include a display 120, such as a liquid crystal display. The display 120 may shown a “TALK” message when the channel is clear, and optionally a “DO NOT TALK” message when the channel is busy. Further, the telephone 100 may use other types of indicators, such as an audible tone played through the speaker 105, vibration, or any other technique to alert the user.

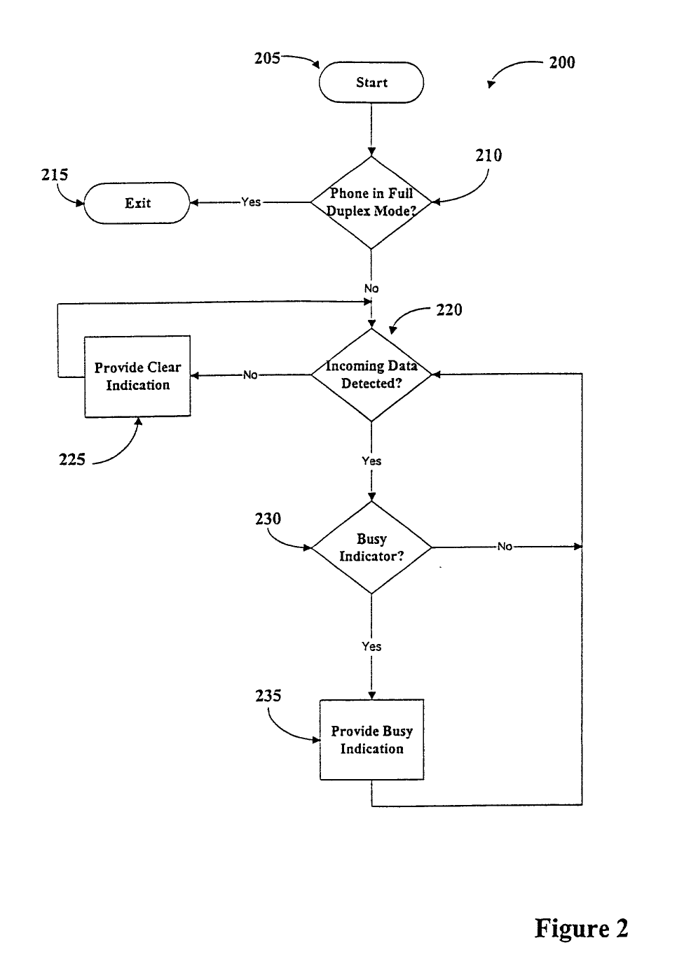

FIG. 2 illustrates the process 200 for providing an indication to the user according to one embodiment that a telephone channel is available for transmission. The process 200 may be part of a software program run on a processor within the telephone 100, or may be part of a hardware logic circuit. The process begins at a start block 205. Proceeding to block 210, the telephone 100 determines whether the current operation is in full duplex mode. In full duplex mode, data may be transmitted in both directions simultaneously. Thus, each party does not have to wait for the other to finish before beginning to speak. Full duplex operation is the standard for most telephone calls. If the telephone 100 is in full duplex mode, the process 200 proceeds along the YES branch to block 215. In block 215, the process 200 determines no indication is necessary during full duplex operation, and the process terminates in the EXIT block 215.

Returning to block 215, if the telephone 100 is not operating in full duplex mode, the use of the indicator 115 may be desired. The telephone 100 may not be operating in full duplex mode when the speakerphone functionality is activated, and the telephone 100 operates in half duplex mode. However, the present invention may be used anytime the telephone 100 is not operating in full duplex mode, and the description involving the speakerphone mode is used only as an example. The process 200 proceeds along the NO branch to block 220. In block 220, the telephone 100 determines whether any data is currently being received over the transmission channel. Any technique known in the art for determining whether data is being received may be used by the present invention. If the telephone 100 is receiving data over the communication channel, the user should not attempt to speak. However, if the channel is clear, the user may transmit data. If no data is detected on the channel, the process 200 proceeds along the NO branch to block 225. In block 225, the telephone 100 provides an indication to the user that the channel is clear. As discussed above, this may be in the form of a green LED in the indicator 115. Of course, other indicators may be used without departing from the spirit of the invention. When the user sees the indication, the user may speak, thus transmitting data onto the channel. After the user has completed speaking, the process 200 proceeds back to block 220 to again determine if any incoming data is detected.

Returning to block 220, if incoming data is detected, the process 200 proceeds along the YES branch to block 230. When incoming data is detected, the telephone cannot transmit data over the channel. In block 230, the process 200 determines whether the telephone is equipped with a busy indicator. As stated above, the present invention may function with only a single indicator, although multiple indicators may be used. Although this embodiment describes and optional busy indicator, it can be appreciated that if a busy indicator is used, the clear indicator may be optional. If the telephone 100 is not using a busy indicator, the process 200 proceeds along the NO branch back to block 220 to again determine if any incoming data is detected.

Returning to block 230, if a busy indicator is being used by the telephone 100, the process 200 proceeds along the YES branch to block 235. In block 235, the telephone 100 provides an indication to the user that the channel is busy. As discussed above, this may be in the form of a red LED in the indicator 115. When the user sees the indication, the user knows not to speak, as data is being received on the channel. Because the user sees the busy indicator, the user does not attempt to speak, and knows that the voice traffic will not be lost. After the busy indication is provided, the process 200 proceeds back to block 220 to again determine if any further incoming data is detected.

Although the present invention was described with reference to controlling the flow of traffic during a speakerphone call, it can be appreciated that the present invention may have additional uses. For example, the present invention may be used to adjust the mute circuit to compensate for ambient noise at the other end of the link. The mute threshold may be adjusted so when the opposite party is not speaking, the clear indicator is lit.

Numerous variations and modifications of the invention will become readily apparent to those skilled in the art. Accordingly, the invention may be embodied in other specific forms without departing from its spirit or essential characteristics.

What is claimed is:

1. A method of providing an indication of a clear channel in a wireless communication system comprising:
monitoring the channel for incoming data; and
providing a first indication when the channel is clear.

2. The method of claim 1, further comprising providing a second indication when the channel is busy.

3. The method of claim 1, further comprising providing a first indication by illuminating a first visual indicator.

4. The method of claim 3, further comprising providing a second indication by illuminating a second visual indicator.

5. The method of claim 1, further comprising providing a first indication by sounding an audible tone.

6. The method of claim 1, further comprising providing a first indication by vibrating.

7. A telephone comprising:
data detection circuitry which detects incoming traffic on a channel; and
a first indicator which activates when the data detection circuitry detects traffic.

8. The telephone of claim 7, further comprising a second indicator which activates when the data detection circuitry does not detect traffic.

9. The telephone of claim 7, wherein the first indicator is a light emitting diode of a first color.

10. The telephone of claim 9, wherein the second indicator is a light emitting diode of a second color.

11. The telephone of claim 7, wherein the first indicator is an audible tone.

12. The telephone of claim 7, wherein the first indicator is a liquid crystal display.

13. The telephone of claim 7, wherein the first indicator vibrates upon activation.

14. The telephone of claim 7, wherein the first indicator sounds an audible tone upon activation.
